(19) United States
(12) Patent Application Publication
(10) Pub. No.: US 2026/0301371 A1
(43) Pub. Date: Oct. 1, 2026

(54) METHODS AND DEVICES FOR AUTOMATED CHARACTERIZATION OF DRILL CUTTINGS

(71) Applicant: UNIVERSITY OF WYOMING, Laramie, WY (US)

(72) Inventors: Amin AMOOIE, Windsor, CO (US); Yanbin GONG, Laramie, WY (US); Mohammad PIRI, Laramie, WY (US)

(21) Appl. No.: 19/479,291

(22) PCT Filed: Apr. 26, 2024
(86) PCT No.: PCT/US2024/026445

§ 371 Date: Oct. 27, 2025

Related U.S. Application Data
(60) Provisional application No. 63/462,669, filed on Apr. 28, 2023.

(51) Int. Cl. G06V 10/764; G01N 23/046; G01N 23/083; G06T 3/4053; G06V 10/10; G06V 10/26; G06V 10/28; G06V 10/40; G06V 10/762

(52) U.S. Cl. CPC G06V 10/764; G01N 23/046; G01N 23/083; G06T 3/4053; G06V 10/16; G06V 10/267; G06V 10/28; G06V 10/40; G06V 10/763; G01N 2223/401; G01N 2223/616

(57) ABSTRACT

A method and system for image processing are disclosed. The method includes image processing by one or more processing units which includes obtaining a set of one or more raw images of a set of drill cutting samples, processing the set of one or more raw images to generate at least a trinary image dataset, a binary image dataset, or both, and extracting a set of features from at least the trinary image dataset, the binary image dataset, or both. The set of features are clustered to associate each of the drill cuttings with at least one representative class, and the set of features are output and the at least one representative class is associated with each of the drill cuttings.

### BACKGROUND

### Field

Aspects of the present disclosure generally relate to imaging of porous media, and more particularly, to image processing for porous media samples.

### Description of the Related Art

Techniques for fluid flow through porous media are broadly implemented for petroleum resource development, materials engineering, food packaging, and medical technology development. Fluid flow modeling techniques may be equipped to illustrate both physical and chemical media properties like permeability, capillary pressure, fluid saturation, contact angle, wettability, or other similar properties, which may be used to characterize fluid behavior.

Although current techniques for modelling fluid flow through porous media are based on technological advancements made over many years, resultant models may still be tenuous representations of actual porous media. For example, fluid flow models of porous media exceeding a few millimeters may require a lower resolution implementation to match currently available computational capabilities. As a result, fluid flow models based on porous media of a larger scale may not accurately reflect physical and chemical properties of the media. Accordingly, there is an impetus to improve the accuracy of fluid flow modeling, including, for example: improving image processing techniques to allow for higher resolution model input and model output, improving image processing techniques to allow for more accurate model input and model output, enhancing computational processing capability to reduce computational expense, enhancing computational processing capability increase modeling speed, increasing automation for iterative modeling steps, improving model capability for dynamic modeling of different fluid flow environments, improving model capability for dynamic modeling of larger fluid flow environments, and the like.

Consequently, there exists a need for further improvements in fluid flow modeling of porous media to overcome the aforementioned technical challenges and other challenges not mentioned.

### SUMMARY

One aspect of the present disclosure provides a method for image processing by one or more processing units. The method may include one or more of obtaining a set of one or more raw images of a set of drill cutting samples, processing the set of one or more raw images to generate at least a trinary image dataset, a binary image dataset, or both, extracting a set of features from at least the trinary image dataset, the binary image dataset, or both, clustering the set of features to associate each of the drill cuttings with at least one representative class; and outputting the set of features and the at least one representative class associated with each of the drill cuttings.

One aspect provides a non-transitory computer-readable medium comprising computer-executable instructions that, when executed by one or more processors, cause one or more processors to perform a method. The method may include one or more of obtaining a set of one or more raw images of a set of drill cutting samples, processing the set of one or more raw images to generate at least a trinary image dataset, a binary image dataset, or both, extracting a set of features from at least the trinary image dataset, the binary image dataset, or both, clustering the set of features to associate each of the drill cuttings with at least one representative class; and outputting the set of features and the at least one representative class associated with each of the drill cuttings.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more message passing interfaces.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only example aspects and are therefore not to be considered limiting of its scope, may admit to other equally effective aspects.

FIG. 1A illustrates an example pore network representation overlaid with a segmented micro-CT image, according to embodiments.

FIG. 1B depicts an example high-resolution porous media images taken by a scanning instrument from a single rock sample and segmented for characterization, according to embodiments.

FIG. 2 depicts an example core-flooding instrument for determining the physical and chemical characteristics of a porous media sample, according to embodiments.

FIG. 3 illustrates and example set of drill cuttings, according to embodiments.

FIG. 4A illustrates example output from a procedure performed by one or more processors, according to embodiments.

FIG. 4B illustrates example output from a procedure performed by one or more processors, according to embodiments.

FIG. 4C illustrates example output from a procedure performed by one or more processors, according to embodiments.

FIG. 4D illustrates example output from a procedure performed by one or more processors, according to embodiments.

FIG. 4E illustrates example output from a procedure performed by one or more processors, according to embodiments.

FIG. 4F illustrates example output from a procedure performed by one or more processors, according to embodiments.

FIG. 5A illustrates a pre-processed gray-scale image volume of a porous media sample, according to embodiments.

FIG. 5B illustrates a representation of color-coded pore bodies following instance segmentation of 3D pore space, according to embodiments.

FIG. 6A illustrates a graph of the pore size distribution of the specimen, according to embodiments.

FIG. 6B illustrates a graph of the sphericity distribution of the specimen, according to embodiments.

FIG. 7 illustrates an example neural network design from a procedure performed by one or more processors, according to embodiments.

FIG. 8 is a flow diagram illustrating certain operations by one or more processing units, according to embodiments.

FIG. 9 is an example device for imaging of porous media, according to embodiments.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

In the following, reference is made to aspects of the disclosure. However, it should be understood that the disclosure is not limited to specifically aspects described. Instead, any combination of the following features and elements, whether related to different aspects or not, is contemplated to implement and practice the disclosure. Furthermore, although aspects of the disclosure may achieve advantages over other possible solutions and/or over the prior art, whether or not a particular advantage is achieved by a given aspect is not limiting of the disclosure. Thus, the following aspects, features, aspects, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

The present disclosure relates to techniques for high-reliability image processing of porous media. Specifically, the techniques discussed herein may be implemented for use in processing accurate, high-resolution images of porous media to produce reliable digital replicates of any porous medium. The porous media may comprise a digital rock sample, a core sample, a plastic sample, a tissue sample, or any other organic or inorganic sample having pore space ascertainable through imaging techniques.

A thorough grasp of fluid flow through pore networks of material with substantial pore space may be consequential to enhancing technical efficacy of fluid flow techniques in a wide range of industries. Models of fluid flow through a porous material may be used to describe physical and chemical characteristic of the material. Such models may help to highlight optimal usage for a certain porous material. In many cases, networks of pores within a material are extremely small, ranging from microscale to nanoscale in size. Techniques for characterizing these pore networks are hindered by the computational expense of modeling at a nanoscale. Often, to alleviate computational burdens, pore network modelling techniques use lower resolution images at the expense of model accuracy. Extrapolation errors caused by low resolution characterization may result in mischaracterization of physical and chemical characteristics of the porous material. Accordingly, ideal modeling of fluid flow through porous media would allow for rapid, accurate nanoscale imaging that may be performed without inhibitive computational expense.

According to certain aspects of the present disclosure, high-reliability image processing of porous material may be achieved through multi-image analysis performed by processing systems operating in parallel. Specifically, overlapping high-resolution images of a porous material, may be obtained by a scanning instrument (e.g., a micro-computed tomography (CT) scanner), stitched together where the images overlap, and processed to obtain a super-resolution image of the porous material. Stitching procedures may be split across one or more central processing units (CPUs) and/or one or more graphics processing units (GPUs) in a parallel processing architecture. This may allow faster, more accurate modeling of porosity information without loss of vital micro-porosity detail.

Implementation of techniques for obtaining reliable digital replicates of porous media samples as described herein may enhance pore network modelling functionality by reducing porous material characterization errors to the benefit of all users seeking a more comprehensive understanding of any given porous material.

### Introduction to Pore Network Modeling

Modeling techniques for fluid flow through porous media may illustrate both physical and chemical porous media properties. Models of porous media may be used to ascertain permeability, capillary pressure, fluid saturation, wettability, buoyancy, and the like to a greater degree of accuracy comparable to physical flooding of a porous media sample. Additionally, physical and chemical properties determined using pore network modeling techniques may be used to characterize in-situ fluid behavior as it travels through the porous media under a wide variety of wettability and flooding conditions. These conditions may not be accessible to users performing conventional physical flooding characterization techniques.

Permeability is the tendency of the porous media to allow liquids to flow through it. Capillary pressure is the pressure difference existing across the interface separating two immiscible fluids. Fluid saturation is the measurement of fluid present in the pore spaces of the porous media. Contact angle is a measured angle between a fluid-fluid or a fluid-gas interface at a point where it meets a solid surface. Wettability is the ability of a liquid to maintain contact with a solid surface. Wettability may vary depending on wettability conditions and the type of wetting liquid present in the porous media sample. For example, a water-wet medium may show a lower wetting affinity to the oil phase than an oil-wet medium, where higher or lower wetting is determined with respect to a given phase. In certain cases, the correlation between wettability and viscosity ratio may not be straightforward, as there may be water or oil wet conditions with similar viscosities.

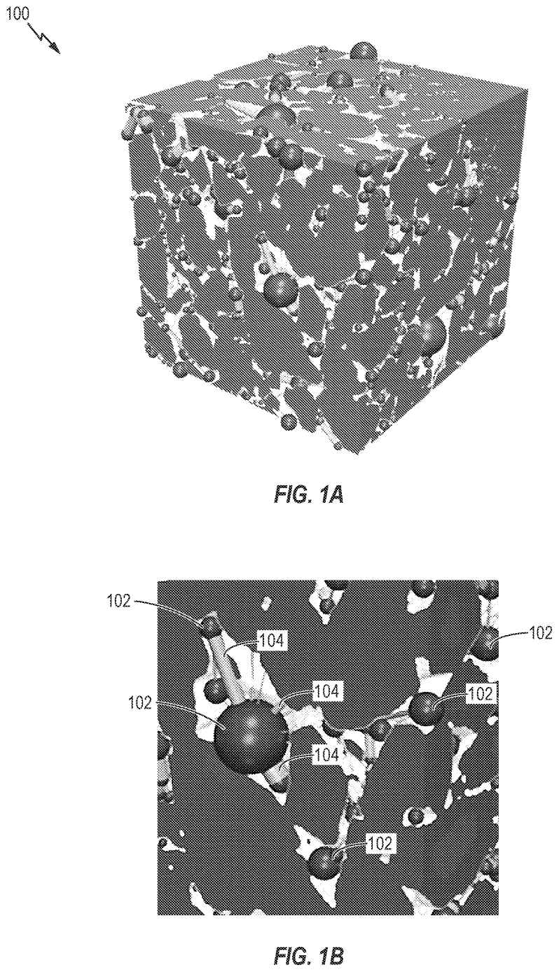

FIG. 1A illustrates an example pore network representation 100 overlaid with a segmented micro-CT image. The pore network is extracted from porous sandstone. A modeled pore network is a practical description of a porous medium targeted for fluid flow modeling. The section of the pore network describes the porosities of various size and shape present in that portion of the sandstone and may be used to model fluid flow through those porosities for various wettability conditions. Three-dimensional (3D) portions of a pore network model may more accurately characterize the porous media sample either alone or in combination with other 3D portions of the pore network model.

Dynamic pore network models may be extracted from images of a targeted porous medium and used to model multi-phase fluid flow using physically based displacement mechanisms (PBDMs) across pores defined in a pore network. PBDMs may represent an estimated displacement of a modeled fluid in response to movement of another fluid or gas within the pore network. As immiscible phases react with one another throughout the pore network during fluid flooding, PBDMs are induced where, for example, capillary pressure across a meniscus exceeds the wettability constraints on either phase. Fluid saturation, contact angle, buoyancy, and the like may also affect PBDMs throughout a pore network. By utilizing a pore network model extracted from a porous media sample, a user may be able to ascertain PBDMs through the porous media sample under a wide variety of wettability conditions in order to ultimately obtain, for example, useful permeabilities for a larger sample of the porous medium without degrading a porous media sample via repeated physical flooding.

FIG. 1B depicts an example high-resolution porous media images taken by a scanning instrument from a single rock sample and segmented for characterization. To properly generate PBDMs at a pore scale for the targeted porous media, imaging may capture complex geometries of the targeted porous media at a resolution sufficiently high to retain acceptable accuracy. Pores may be defined as a complex polyhedron having at least a center 102 and spherical and effective diameters. Connective throats 104 between pores may also be defined. In many cases, image resolution may be in micrometers or nanometers to capture applicable pore detail. High-resolution pore models allow for accurate rendering of the fluid flow characteristics described above as ascertained at each pore and for each PBDM.

PBDMs may occur upon flooding or draining of a dynamic pore network model, where aqueous phase injection or removal is iteratively simulated through the pore network. Aqueous flooding and aqueous draining may be implemented in various modeled wettability conditions, where certain fluids are present prior to the start of a simulation. Wettability conditions may include at least water-wet, oil-wet, or mixed-wet conditions. During aqueous flooding, injected water may displace immiscible fluid preexisting in the pore network model. During aqueous draining, injected immiscible fluid may displace water preexisting in the pore network model. In certain cases, flooding and draining may be fluid flooding and fluid draining. In some cases, fluid may be oil.

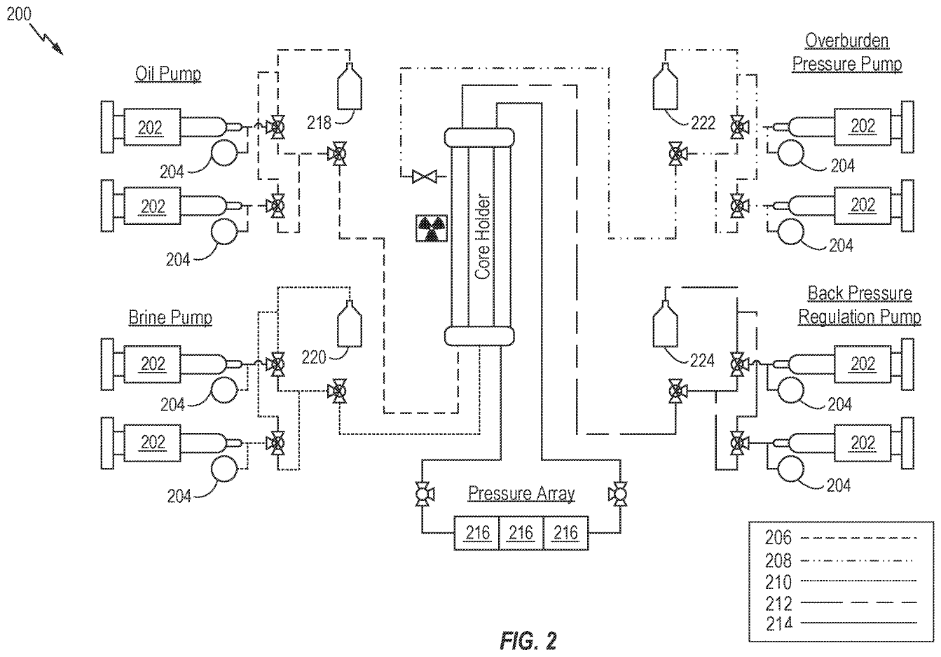

FIG. 2 depicts an example core-flooding instrument for determining the physical and chemical characteristics of a porous media sample. Flooding or draining of a dynamic pore network model may be simulated based in part on scanned images of physical flooding implemented by a flooding instrument 200. In some cases, a porous media may undergo a core-flooding experiment to establish an irreducible water saturation, a residual oil saturation, or both. Core-flooding may be enabled by a set of pumps 202, rupture disks 204, pump lines 206-214, differential pressure transducers 216, and source buckets 218-222 working in tandem to flood a porous media sample loaded in a core holder. In some cases, a scanning instrument (e.g., a micro computed tomography (micro-CT) scanner) captures a dry reference image prior to flooding. Scanning occurs in a field of view defined within the core holder. In some cases, the porous media sample may be flooded with brine from bucket 220 via the brine tubing line 206 and scanned again to ensure that the porous media sample is fully saturated. Once the brine flooding is complete, the absolute permeability of the porous media sample may be obtained. The oil flooding may be performed alongside additional brine flooding. Any fluid expelled as a result of overburden pressure (i.e., pressure that compacts pore space and reduces permeability) may be transported via the confining fluid line 208 and collected in bucket 222. Any fluid expelled as a result of the flooding procedure may be transported via the effluent fluid line 212 and collected in bucket 224. In many cases, core sample pressure may be iteratively adjusted during flooding. Pressure may be recorded by one or more differential pressure transducers 216 coupled to the core holder via a transducer line 214.

Scanned images obtained from flooding procedures performed by the flooding instrument 200 of FIG. 2 may be used to extract a pore map representative of the porous media sample. The images may be processed to determine characteristics of fluid flow through the porous media sample. In many cases, the images may also be used to extract a representative pore network model.

Imaging of porous media is typically performed using micro-CT imaging. In many cases, commercial micro-CT scanners (e.g., Zeiss scanners) are available for imaging necessary to perform pore network modelling. Images of porous media taken by micro-CT scanners are at a sufficiently high resolution to create a microscale digital image of the porous media.

In the current state of the art, there exists a challenge of extracting porous media characteristics in a manner precise and repeatable to ensure the ultimate stability of future simulations. Currently, techniques for porous media characterization require lengthy step-wise processing known to incur undue computational expense and introduce instability to characterization of the porous media sample. As a result, users may not be able to rely on characterization output to simulate flow conditions in a useful way.

### Aspects Related to Automated Characterization of Drill Cuttings

In the current state of the art, there exists a challenge of predicting fluid flow through porous media in a manner precise and repeatable to ensure the ultimate stability of future simulations. Currently, techniques for two-phase fluid flow prediction require lengthy step-wise processing known to incur undue computational expense and introduce instability to characterization of the porous media sample. As a result, users may not be able to rely on characterization output to simulate flow conditions in a useful way.

Fluid flow modelling through porous media is often utilized to enhance petroleum resource development. In recent years, global demand for energy resources has mobilized development of petroleum reservoirs as targets for hydrocarbon extraction. The geological formations that comprise these hydrocarbon reservoirs are ultra-tight shale formations resistant to primary petroleum extraction techniques. A matrix of an ultra-tight shale reservoir may be characterized by low permeability and low porosity. To extract hydrocarbons from the ultra-tight shale matrix, secondary and tertiary petroleum extraction techniques seek to maximize oil production through the microscale pore networks that comprise a substantial amount of the porosity in the shale matrix.

A robust understanding of fluid flow through microscale pore networks of unconventional reservoirs may be consequential to extracting the trillions of barrels of oil still housed in shale formations globally. Models of fluid flow through a pore network that describe permeability, capillary pressure, fluid saturation, and wettability may help to elucidate specific steps to be taken during resource development to optimize petroleum production. Even so, techniques for characterizing these microscale pore networks are hindered by the computational expense of modeling sub-resolution pore network and extrapolation errors caused by unstable characterization of pore geometries.

As discussed above, ideal modeling of fluid flow through porous media would allow for high resolution imaging of a macro-sized porous media sample. In a case where the porous media sample is, for example, a cylindrical core sample of a rock having a length of six inches and a diameter of one inch, the core sample is likely to have porosity and permeability that vary across its length and width. This is common in core samples, and especially in core samples representative of ultra-tight oil formations. Geological processes that form certain oil-bearing rocks can produce heterogeneous morphological features in the rock that may be present even at a nanometer scale. This is especially true for oil bearing carbonate rocks, which contain micro-porosities that contribute significantly to the overall porosity of the rock. These nanoscale morphological features may affect the pore network of the core sample, altering the porosity and permeability throughout a core sample. Thus, accurate characterization of fluid flow through a core sample may depend on nanoscale resolution sufficient to detect heterogeneous properties of a pore network.

Numerical computation from high-resolution 3D micro-tomographic images of rocks, also known as Digital Rock Technologies (DRT), has the potential to more accurately predict the underlying petrophysical properties and macroscopic flow behavior of fluids within such porous media. The first component of DRT is image processing of micro-CT images, which may entail processing of images obtained by micro-CT scanner in the lab. Ideally, DRT may accurately and efficiently render and process the obtained image datasets, which may allow a user to obtaining reliable digital replicates that are in one-to-one correspondence to the rock samples. However, in the current state of the art, DRT is limited to samples with simple structure and mineralogy and is disadvantaged by low computational efficiency, ultimately making DRT less than desirable to process large image datasets (high resolutions and/or large physical sample sizes). Additionally, the majority of existing attempts require continuous end-user input and interaction for each case. This prevents scaling out by preventing automated execution and batch processing of a number of cases. There also exists a challenge in processing multi-mineral rocks that are presented using grayscale values of different minerals in micro-CT images, because those value are often very similar.

Techniques presented herein provide methods and devices for clustering drill cuttings and mapping such drill cuttings to core plugs, based at least in part on their micro-CT images. Techniques described herein may provide an automated, efficient, and accurate way to group drill cuttings into different classes, each representing an underlying lithological facies.

In some cases, if core plugs are available, one or more processors may cluster input drill cuttings into their representative facies. In some cases, one or more processors may perform feature extraction from the micro-CT images using computer vision techniques for texture analysis. Vision techniques may include gray-level co-occurrence matrix analysis, principal component analysis (PCA) and auto-encoders. Aspects described herein may include one or more processors preprocessing and segmenting gray-scale images (e.g., raw micro-CT images) into trinary images containing three regions. In some cases, trinary regions may be defined as pores, clays and grains. In some cases, one or more processors may extract features, including pore-size distribution, porosity measures, as well as pore and grain structural characteristics such as aspect ratio and sphericity, from binary images using advanced image analysis techniques including distance-transform watershed-based instance segmentation. The extracted features from gray-scale and segmented images are then used to train unsupervised k-means clustering and Gaussian mixture models (GMMs) machine-learning algorithms, which may automatically group the drill cuttings into different classes that represent the underlying facies. These techniques may provide an efficient and robust approach to identifying the facies of drill cuttings with a high degree of accuracy.

Drill cuttings are pieces of rocks and a byproduct of drilling cores (e.g., from oil and gas reservoirs). These cuttings can vary in size, shape, and pore microstructure, depending in part on the depth at which they are gathered and the sedimentary facies from which they originated. The ability to identify the facies associated with drill cuttings is an important step in reservoir characterization and can provide valuable information about the nature and properties of the subsurface lithology.

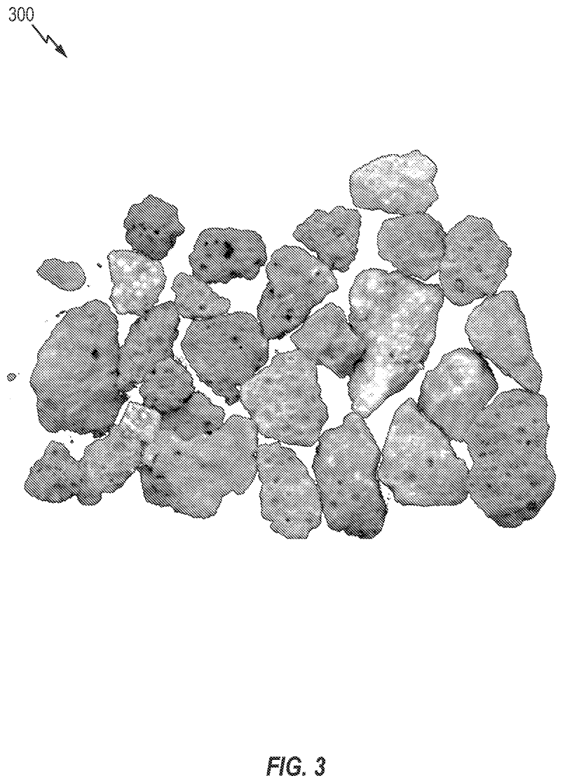

Example drill cuttings 300 are illustrated in FIG. 3. Drill cuttings are fragments of a porous media sample (e.g., a rock sample) generated during well drilling. In situations where core output is low, such as when drilling through weakly cemented reservoirs with high porosity and permeability, collecting cutting samples becomes necessary. However, the information obtained from analyzing drill cuttings is limited. Generally, cutting analysis is used to supplement routine and special core analysis in order to acquire more detailed geological and petrophysical information when core data is unavailable. However, because the drill cutting are irregular and lack coordination with any specific geologic facies, information as available in the current state of the art is subject to error.

Having an efficient cuttings analysis technology may decrease drilling costs and time. As an example, partially replacing 75% of core drilling with reverse circulation (RC) drilling (which involves cuttings sampling) could lead to substantial financial and time savings.

There are numerous issues with utilizing drill cuttings in DRT. In one example, drill cuttings are typically small, irregularly shaped, and fragmented, which makes it difficult to obtain a representative volume or an accurate representation of the porous media microstructure. In another example, sample preparation may be difficult because proper sample preparation is crucial for DRP analysis. Cleaning, mounting, and polishing cuttings can be difficult due to their small size and irregular shape. This can lead to inaccuracies in imaging and simulations. In another example, high-resolution 3D imaging techniques like X-ray micro-CT are often used in DRT studies. However, drill cuttings may require even higher resolutions to capture the intricate pore structures accurately, which may be challenging and time-consuming. In another example, obtaining a representative sample from drill cuttings may be challenging, as they may not accurately represent the entire formation. The small size of cuttings can limit the ability to detect and analyze macroscopic features or variations in the porous media. In another example, geological formations may be highly heterogeneous, with varying mineralogy, porosity, and permeability. Accurately capturing this heterogeneity in a small, fragmented sample of drill cuttings can be difficult. In another example, the drilling process can cause mechanical damage to the cuttings, including crushing, smearing, or alteration of the original rock fabric. This can affect the accuracy of DRT analysis.

It is not feasible to perform facies detection solely based on the physical appearance of cuttings. Traditionally, well logging may be used to identify the lithological strata within a depth of a reservoir. Well logging may not be consistently available, and accuracy of field-scale measurements may not always be sufficient. Aspects of the present disclosure provide techniques to enable a user to gain more refined insight into drill cuttings and into the corresponding reservoir. Aspects described herein may be based, solely or in part, on micro-CT images of drill cutting internal microstructure. In some cases, aspects of the present disclosure are implemented by one or more processors using an automated and objective approach to drill cutting characterization.

According to certain aspects of the present disclosure, the automated porous media typing for both drill cuttings and core plugs as well as a physical characteristic correlation between cuttings and cores allows one or more processors to inform and optimize the selection of cuttings such that all the facies of a reservoir that may be incorporated into a DRT workflow. The knowledge of, for example, a lithological map between cuttings and cores may serve as a guide to select the most representative samples for validation studies.

Aspects of the present disclosure are based on micro-CT images of porous media samples (e.g., drill cuttings), which provide high-resolution 3D representations of the internal pore microstructure of the samples. In some cases, processors (e.g., a central processing unit (CPU) and/or graphics processing units (GPUs)) may perform one or more steps to generate drill cutting characterization and mapping. First, one or more processors may obtain high-resolution micro-CT images of a set of drill cuttings. The processors may then pre-process and segment the raw gray-scale micro-CT images to obtain the trinary image dataset for each drill cutting. Extracting relevant features from the gray-scale and segmented image datasets may be performed using computer vision techniques, including gray-level co-occurrence matrix analysis (GLCM), gray-level size-zone matrix (GLSZM), PCA, auto-encoders, and instance segmentation using distance transform watershed to segment the pore region into individual pore and throat bodies. The processors may then apply a suitable clustering algorithm, such as k-means or GMMs, to the feature space to group the drill cuttings into different classes representing underlying facies. In some cases, the processors may validate the clustering results using suitable metrics (e.g., silhouette analysis, adjusted Rand index, etc.).

Aspects of the present disclosure provide techniques for image processing that utilize highly parallelized denoising and filtering techniques. Techniques described herein also provide an AI-assisted, CPU-parallelized, and GPU-accelerated automated segmentation workflow that combines adaptive local thresholding, watershed segmentation, and clustering techniques to seamlessly segment a variety of images into multiple phases and infer under-resolved regions of complex porous media.

In some cases, if any porous media Routine Core Analysis measurements are available, the processors may begin to implement a drill cutting characterization workflow after 3D micro-CT images of a selection of drill cuttings and available cores are obtained. Following pre-processing, filtering, and segmentation of the images from plugs, the one or more processors conduct comprehensive pore and grain structure analysis to calibrate the framework. In particular, the one or more processors may calibrate the image processing using a prediction of total porosity as compared to and calibrated against Routine Core Analysis measurements of various physical porous media. The detailed measurement of macro-and micro-porosity through the image-based inference of the under-resolved phase may predict a total porosity value for any or all of the provided drill cuttings. If such calibration is not warranted, the one or more processors may proceed with pre-processing the drill cuttings images and normalizing their gray-scale intensity, followed by the segmentation. In some cases, the processors may maintain certain model parameters for all drill cuttings.

Once the one or more processors obtain trinary images from the raw drill cutting images, the one or more processors may perform instance segmentation. In some cases, the processors may perform instance segmentation via a 3D distance transform watershed procedure, which segments 3D pore space into labeled pore bodies separated by interfaces that represent the throats or constrictions within a pore region.

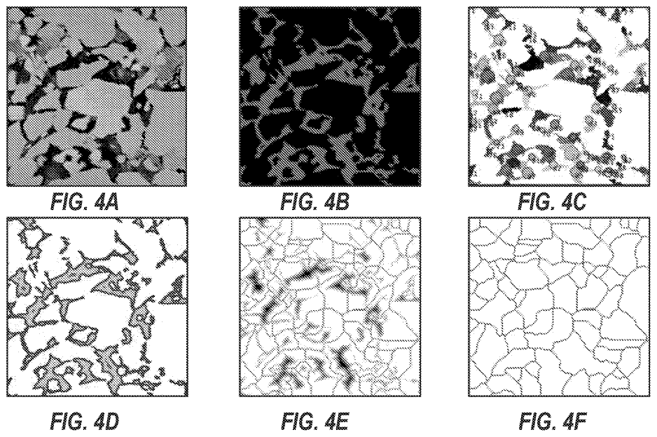

FIGS. 4A-4F illustrate example output for each of the steps implemented by the one or more processors during instance segmentation. FIG. 4A illustrates a gray-scale image. FIG. 4B illustrates a binarized image. FIG. 4C illustrates an instance segmentation image. FIG. 4D illustrates a distance map image. FIG. 4E illustrates a watershed on inverse distance map image. FIG. 4F illustrates a watershed lines image. By combining distance transform and the watershed procedures, the one or more processors create borders as far as possible from the center of the overlapping objects, denoted as watershed lines that represent the constrictions or throats.

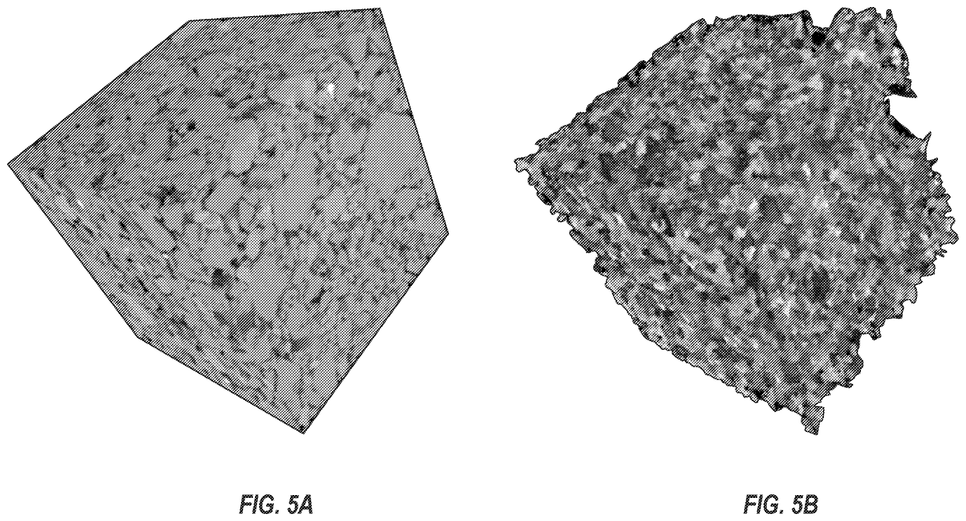

FIG. 5A illustrates a pre-processed gray-scale image volume of a porous media sample. FIG. 5B illustrates a representation of color-coded pore bodies following instance segmentation of 3D pore space. The images show the results of instance watershed based on 3D distance transform watershed for a typical sandstone core sample.

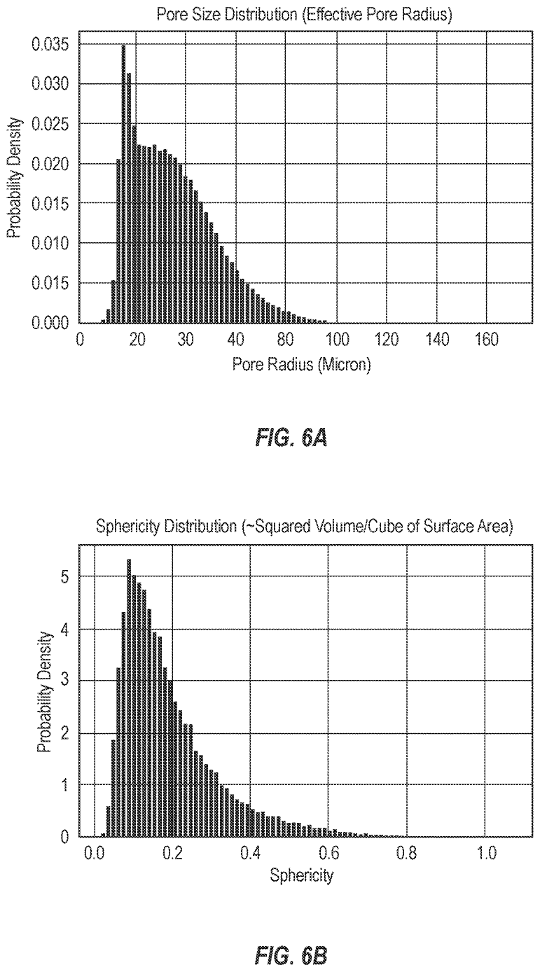

FIG. 6A illustrates a graph of the pore size distribution of the specimen. FIG. 6B illustrates a graph of the sphericity distribution of the specimen. After image segmentation, the one or more processors may perform feature extraction using 3D morphological region analysis that calculates one or more of total porosity of the specimen, effective pore radius, maximum inscribed ball radius, Euler characteristic number, sphericity, aspect ratio of pores, and other statistical measures.

The features mentioned above may provide key information on statistical distribution of pore microstructure for full-scale segmentation of the 3D image stack. In some cases, full-scale segmentation of the 3D image stack may be computationally expensive for a high number of drill cuttings. To alleviate this computational expense, the one or more processors may utilize gray-scale images of drill cuttings for feature extraction. Three approaches for utilizing gray-scale images of drill cuttings are proposed herein, but are not limiting of the scope, applicability, or aspects set forth in this disclosure.

A first approach uses GLCM and GLSZM, analysis, according to certain aspects of the present disclosure. Micro-CT images are 3D voxel-based representations of porous samples captured at a particular image resolution. The intensity of each voxel may correspond to the material encountered by X-rays, with low intensity representing pores or empty spaces, high intensity representing solid components (e.g., silicate, calcite, apatite, bauxite, plastics, etc.), and very-high intensity representing significantly dense components (e.g., iron oxides, pyrite, barite, other metals, plastics, etc.). The variation in intensity levels may be analyzed using three main procedures: histograms, GLCM, and GLSZM. These procedures are dimension reduction techniques that summarize a large amount of information into principal components, making them critical for analyzing data with high dimensions and complexity, such as porous media images.

Gray-level histograms are a preliminary dimension reduction technique that represent features of a porous structure as a frequency-based distribution. As the simplest representation for a 3D micro-CT image, histograms illustrate the dominant components identified as modes of the histogram distribution. In addition to histograms, techniques described herein may allow the one or more processors to apply pattern recognition and texture analysis techniques to supplement histogram information.

GLCM performed by one or more processors may produce spatial information by analyzing the neighborhood of a reference pixel using different angles and distance parameters, allowing for directional analysis at different scales. GLSZM is direction independent and may also produce spatial information of gray-level intensities by analyzing their connectivity in a 3D manner. In many cases, GLSZM procedures implemented by one or more processors may highlight both dominant and minor features. Dominant features may occur as peaks with high-to low-connectivity. Minor features may occur as medium-to low-connectivity peaks.

In some cases, the one or more processors may use GLCM representation to extract principal information about texture of each drill cutting sample. Using this information, the one or more processors may classify the dataset based on physical (e.g., mineralogical, petrophysical, lithological) heterogeneities associated with different facies. In particular, the second-order statistics from GLCM may be obtained to better understand porous media sample structure in terms of grain sizes, anisotropy, and heterogeneity. Furthermore, the dominant and minor features obtained by GLSZM may be used as analogs to porosity and permeability of drill cuttings. Such analogs allow the one or more processors to proceed without completely processing and segmenting the images and/or performing fluid flow procedures. Using these statistical analogs, the processors may also be able to infer grayscale representative elementary volumes (GREVs) of different drill cuttings of various sizes in an efficient and robust manner.

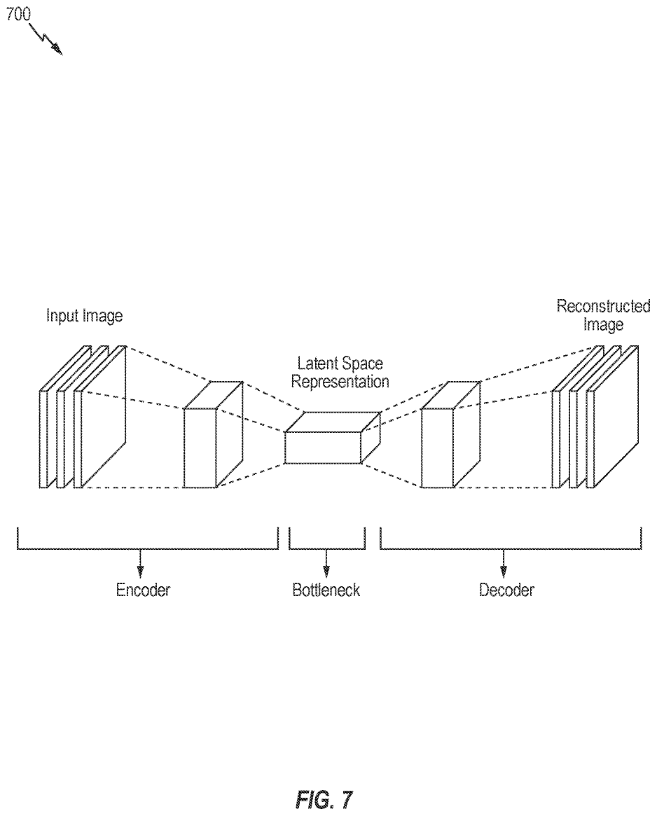

FIG. 7 illustrates an example neural network 700 design from a procedure performed by one or more processors. A second approach uses PCA and auto-encoders. In some cases, the one or more processors may extract key features from micro-CT 3D image features using PCA and auto-encoders, which are unsupervised machine learning techniques that can capture the underlying patterns and variations in images. PCA and auto-encoders are machine learning and computer vision techniques used for feature extraction from high-dimensional data, such as images. These techniques aim to reduce the dimensionality of the data while retaining the most relevant information that distinguishes the different samples. PCA is a linear transformation technique that identifies the principal components of the data, which are the directions along which the data varies the most. By projecting the original data onto these principal components, PCA techniques effectively reduce the dimensionality of the data while retaining most of its variability. The resulting principal components may be used as features for clustering or classification tasks. Auto-encoders are a type of neural network designed to learn a compressed representation of the input data. An auto-encoder is designed to learn efficient data representations (e.g., encoding) by training the network to ignore signal “noise.” Particularly, auto-encoders consist of an encoder network that maps the input data to a lower-dimensional representation, and a decoder network that reconstructs the original data from the compressed representation. The encoder network can be trained using unsupervised learning techniques such as auto-encoder reconstruction error minimization. Once the encoder network is trained, the output of its bottleneck layer can be used as features for clustering or classification tasks.

According to certain aspects of the present disclosure, one or more processors may use both PCA and auto-encoders to extract relevant features from the micro-CT 3D images of drill cuttings. These features can capture the underlying patterns and variations in the images that distinguish one facies from another. By using these features as part of the inputs feature space to a clustering algorithm, techniques described herein are able to group the drill cuttings into different clusters that correspond to different facies.

The number of principal components needed to capture the underlying structure of the data may vary depending on the complexity of the problem and the amount of variance illustrated for each component. While it is possible that one principal component is enough to capture the majority of the variability in the dataset, it is also possible that multiple principal components may better capture the variability in the dataset. The one or more processors may perform a scree plot analysis to determine the number of principal components to retain. A scree plot shows the eigenvalues of each principal component in decreasing order, and the platform automatically finds the point where the eigenvalues level off, indicating the point beyond which additional principal components do not contribute much to the variability in the data.

A third approach uses feature extraction. In a case where the one or more processors have obtained 3D image datasets for a number, N, of drill cuttings, the processors may implement certain steps to perform feature extraction. First, the one or more processors may perform a 3D multi-label semantic segmentation using a highly parallelized, AI-assisted marker-controlled compact watershed procedure. This procedure, which outputs a trinary image defining pores, clay (e.g., clays having micro-porosity), and grain regions. The processors may then perform instance segmentation of a binary image (e.g., a binary image containing a pore component and a second component represented as the sum of grain and clay components). The instance segmentation may be based on 3D distance transform watershed, and may be conducted to segment the 3D pore space into labeled pore bodies and throat interfaces.

In some cases, the processors perform 3D morphological region analysis to obtain key features, including one or more of at least total porosity of the specimen, effective pore radius, maximum inscribed ball radius, Euler characteristic number, sphericity and aspect ratio of pores. During this step, the processors may output a number of features equivalent to 6×N features.

Next, the one or more processors perform GLSM on gray-scale images for statistical texture analysis of drill cuttings. The processors may calculate several second-order statistical measures according to the following: (1) GLCM contrast describing local variation in the gray-level intensities, (2) GLCM angular second moment, describing the rock homogeneity; (3) GLCM mean, describing weighted average of the probability of occurrence of features based on their location on the GLCM map; and (4) GLCM correlation, measuring the linear dependencies of grayscale values and the degree of (an) isotropy in the micro computed tomographic images of each of the rock types. During this step, the processors may output a number of features equivalent to 4×N features.

In some cases, the processors may proceed by implementing GLSZM to analyze gray-scale images of drill cuttings. The processors may calculate statistical descriptors of pore space to understand the connectivity of low gray-level intensities. Specifically, two statistical measures may be implemented to describe the pore space of the porous media sample: Low Gray-Level Emphasis (LGE) describing the entire pore-space region of low gray-levels and Large Area Low Gray-Level Emphasis (LALE) describing large, connected pore space of low gray levels. LGE may be understood as an analog to porosity, while LALE is associated with permeability. This step outputs 2×N features.

The processors may then extract features from the 3D gray-scale image dataset via PCA according to the following procedure: First, the processors reshape each 3D binary image stack into a 1D array. Next, the one or more processors apply PCA to one of the 1D arrays associated with one drill cutting, and perform the scree plot analysis to determine the number of principal components to retain, denoted as P. The processors then apply PCA to a number, N, 1D arrays, resulting in NXP principal components as features for clustering.

In some cases, the processors may use an auto-encoder to extract features from the 3D image dataset as follows: First, the one or more processors design an auto-encoder architecture that takes a 3D image stack as input and outputs a compressed representation of the image. The processors train the auto-encoder using the N image stacks, and extract the compressed representations of the N image stacks from the bottleneck layer of the trained auto-encoder. In some cases, the processors apply the GLCM, GLSZM, PCA and auto-encoders to gray-scale images, but it also allows their execution on binary segmented images. The former leads to extraction of features that better capture the overall shape and structure of the drill cuttings since gray-scale images may be more informative as they preserve the intensity information. Depending on the performance of grouping the cuttings into different facies, features from binary images may be added to, or replace, those extracted from the gray-scale images.

Aspects of the present disclosure seek to automate micro-CT analyses of drill cuttings and reservoir core plugs by pattern recognition and machine learning. Using advanced clustering algorithms, techniques described herein allow one or more processors to group the drill cuttings into different clusters based on the extracted features that can capture the underlying patterns and variations in the images as described above. If the number of clusters k, corresponding to the number of facies, is known a priori, for instance through geological interpretations and the knowledge of depth interval at which the cuttings were gathered, then a k-means clustering algorithm with k clusters may be selected. Next, the one or more processors can apply k-means clustering to the resulting feature matrix to group the drill cuttings into k facies based on their feature similarity, using the following workflow: First, the processors initialize the k-means algorithm with k cluster centroids and train the procedure on the feature matrix. Then, the processors assign each 3D image stack to the cluster with the nearest centroid and visualize the resulting clusters to see if they correspond to different facies.

If the number of facies is not known in advance, the number of clusters may be determined by evaluating the within-cluster sum of squares (inertia) under a number of k. The k where additional number of clusters do not substantially decrease the inertial is the optimal k. Silhouette score may also be implemented, which provides a measure of how well the data points fit into their assigned clusters. Once the number of clusters is determined, the processors implement a procedure to assign each sample to the nearest cluster center based on their feature vectors.

To complement the k-means clustering, a model-based clustering procedure, the one or more processors implement GMM, which is used to automatically estimate the number of underlying facies in a set of drill cuttings based on their micro-CT images. The basic idea behind GMMs is to model the distribution of the data as a mixture of several Gaussian distributions, where each component represents a distinct underlying facies.

To apply GMMs to the problem of grouping drill cuttings, the one or more processors first extract relevant features from the micro-CT images using techniques described above. These features may then be used as input to the GMM procedure, which estimates the parameters of the underlying Gaussian mixture model based on the observed data. One of the advantages of GMMs is that they can estimate the number of components in the mixture model automatically, without requiring prior knowledge of the number of facies. This may be achieved by using information criteria, such as the Bayesian Information Criterion (BIC) or the Akaike Information Criterion (AIC), which are statistical measures of the goodness of fit of a model and penalize models with more components to avoid overfitting.

Once the GMM model is trained, it can be used to predict the most likely facies for each individual drill cutting based on the posterior probabilities of belonging to each component. This may be performed using maximum a posteriori (MAP) estimation. One limitation of GMMs, however, is that they assume that the underlying facies are Gaussian distributions, which may not always be the case in practice. Therefore, the one or more processors may also explore (e.g., simultaneous explore) both k-means clustering and GMM approaches to reach a definite conclusion on the number of facies.

Certain aspects of the present disclosure provide techniques for mapping drill cuttings to cores. For example, when there are core plugs available from a geological reservoir, there may be some interest in finding the correlation between those plugs and the drill cuttings that were acquired from the same reservoir. Accordingly, techniques for mapping the drill cuttings to the facies exemplified in the cores may be useful, especially for calibration and validation studies in the lab, and for use in DRT. Techniques described herein may be implemented by one or more processors to find this information.

In some cases, to map the identified drill cuttings to corresponding core plugs, one or more processors may act according to the following steps: First, the one or more processors obtain high-resolution 3D images of the core plugs using micro-CT scanning and pre-process and segment the images to obtain trinary and binary image datasets for each core plug. The one or more processors then modify image resolution using bi-cubic interpolation such that all rock and drill cutting samples have the same resolution. The processors use the same feature extraction techniques used for the drill cuttings to extract features from the binary image datasets of the core plugs. Next, the one or more processors apply similar clustering procedure as those described above to cluster the core plugs based on their features. This may group the core plugs into different classes that may correspond to different facies. The processors then apply the same clustering algorithms to drill cuttings to group them into different classes that may correspond to different facies.

Once the number clusters for core plugs and drill cuttings are obtained, they are compared against each other; whichever case has a larger number of clusters or facies represents the reservoir in a more refined and inclusive manner. The trained clustering procedure with higher number of clusters is applied to feature space of the other case (e.g., plugs vs. cuttings) to infer the refined facies to which they belong. These steps are repeated on a combined set of feature vectors from both plugs and cuttings to ensure the accuracy of the inference.

Next, the one or more processors compute the mean feature vector for each cluster of core plugs and compare it to the feature vectors of the drill cuttings to determine the closest match and further ensure the accuracy of mapping between plugs and cuttings. If the processors are able to generate a valid correlation map, the processor update the sampling of cuttings, and the steps above are repeated until a similarity map is established between the core plugs and the new drill cuttings. In some cases, the one or more processors may check the validity of the obtained results against any available and reliable geological or well log information.

Aspects described herein provide an automated approach for classifying drill cuttings into different facies based on micro-CT high-resolution 3D images without the need for manual labeling or prior knowledge of the number of facies. One or more processors may use feature extraction techniques such as PCA or auto-encoders to capture the underlying patterns and variations in the images and clustering procedures such as GMMs or k-means to group the samples into different classes that represent the underlying facies.

### Example Methods

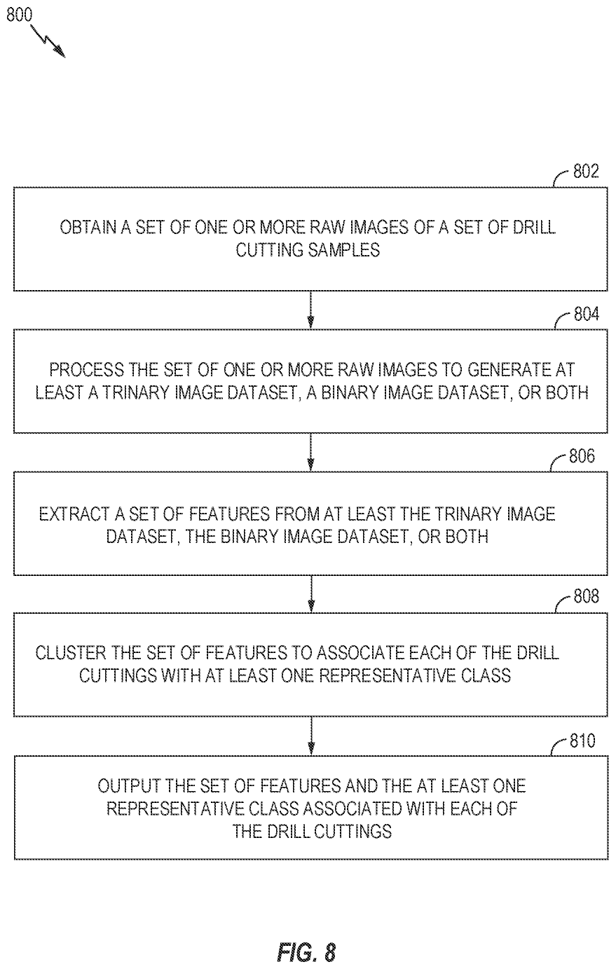

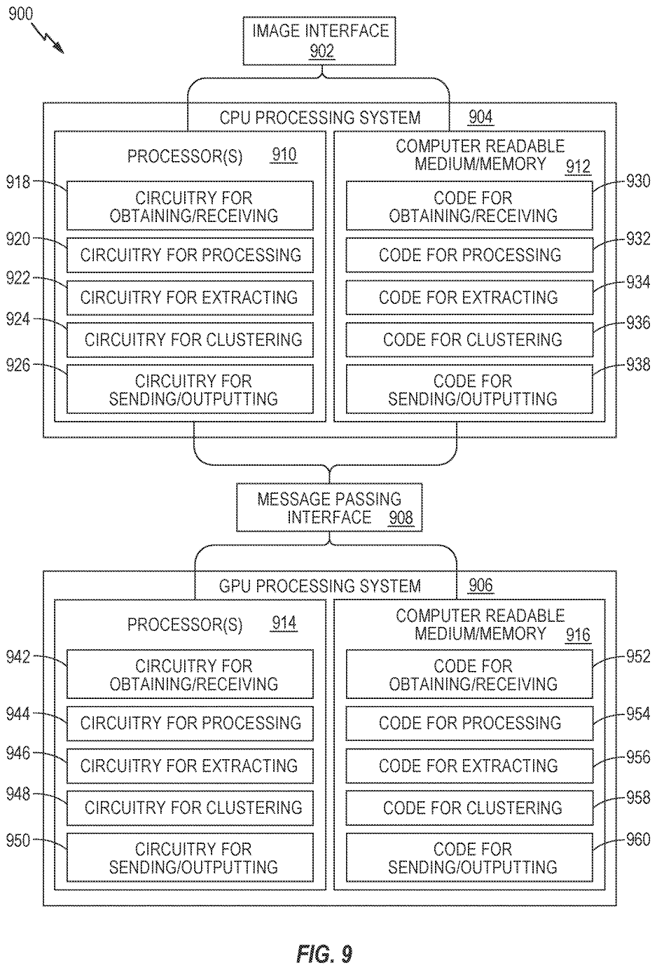

FIG. 8 depicts a method 800 for processing images of porous media by one or more processing, such as the CPUs and/or GPUs of the device 900 of FIG. 9.

Method 800 begins at operation 802 with one or more processing units obtaining a set of one or more raw images of a set of drill cutting samples.

Method 800 continues to operation 804 with one or more processing units processing the set of one or more raw images to generate at least a trinary image dataset, a binary image dataset, or both.

Method 800 continues to operation 806 with one or more processing extracting a set of features from at least the trinary image dataset, the binary image dataset, or both.

Method 800 continues to operation 808 with one or more processing units clustering the set of features to associate each of the drill cuttings with at least one representative class.

Method 800 continues to operation 810 with one or more processing outputting the set of features and the at least one representative class associated with each of the drill cuttings.

In one aspect, method 800, or any aspect related to it, may be performed by an apparatus, such as imaging device 900 of FIG. 9, which includes various components operable, configured, or adapted to perform the method 800. Device 900 is described below in further detail.

Note that FIG. 8 is just one example of a method, and other methods including fewer, additional, or alternative steps are possible consistent with this disclosure.

### Example Device

FIG. 9 depicts aspects of an example porous media device 900. In some aspect, the device 900 comprises one or more CPUs, one or more GPUs, or both as described above with respect to FIG. 8.

The device 900 includes a CPU processing system 904 coupled to an image interface 902 (e.g., a user interface or and/or an image generator such as a commercial micro-CT scanner). The CPU processing system 904 may be configured to perform processing functions for the device 900, including multiscale imaging of porous media generated by the device 900.

The CPU processing system 904 includes one or more processors 910. The one or more processors 910 are coupled to a computer-readable medium/memory 912 via a bus. The one or more processors 910 and the computer-readable medium/memory 912 may communicate with the one or more processor 914 and the computer-readable medium/memory 916 of the GPU processing system 906 via a message passing interface (MPI) 908. In certain aspects, the computer-readable medium/memory 912 is configured to store instructions (e.g., computer-executable code) that when executed by the one or more processors 910, cause the one or more processors 910 to perform the method 800 described with respect to FIG. 8, or any aspect related to it. Note that reference to a processor performing a function of device 900 may include one or more processors performing that function of device 900.

In the depicted example, computer-readable medium/memory 912 stores code (e.g., executable instructions) for obtaining/receiving 930, code for processing 932, code for extracting 934, code for clustering 936, and code for sending/outputting 938. Processing of the code 930-938 may cause the imaging device 900 to perform the method 800 described with respect to FIG. 8, or any aspect related to it.

The one or more processors 910 include circuitry configured to implement (e.g., execute) the code stored in the computer-readable medium/memory 912, including circuitry for obtaining/receiving 918, circuitry for processing 920, circuitry for extracting 922, circuitry for clustering 924, and circuitry for sending/outputting 926. Processing with circuitry 918-926 may cause the imaging device 900 to perform the method 800 described with respect to FIG. 8, or any aspect related to it.

Various components of the device 900 may provide means for performing the method 800 described with respect to FIG. 8, or any aspect related to it. Various components of the device 900 may provide means for performing the method 800 described with respect to FIG. 8, or any aspect related to it.

The device 900 includes a GPU processing system 906. The GPU processing system 906 may be configured to perform processing functions for the device 2000, including multiscale imaging of porous media generated by the device 900.

The GPU processing system 906 includes one or more processors 914. The one or more processors 914 are coupled to a computer-readable medium/memory 916 via a bus. The one or more processors 914 and the computer-readable medium/memory 916 may communicate with the one or more processor 910 and the computer-readable medium/memory 912 of the CPU processing system 904 via an MPI 908. In certain aspects, the computer-readable medium/memory 916 is configured to store instructions (e.g., computer-executable code) that when executed by the one or more processors 914, cause the one or more processors 914 to perform the method 800 described with respect to FIG. 8, or any aspect related to it. Note that reference to a processor performing a function of device 900 may include one or more processors performing that function of device 900.

In the depicted example, computer-readable medium/memory 916 stores code (e.g., executable instructions) for obtaining/receiving 952, code for processing 954, code for extracting 956, code for clustering 958, and code for sending/outputting 960. Processing of the code 952-960 may cause the imaging device 900 to perform the method 800 described with respect to FIG. 8, or any aspect related to it.

The one or more processors 914 include circuitry configured to implement (e.g., execute) the code stored in the computer-readable medium/memory 916, including circuitry for obtaining/receiving 942, circuitry for processing 944, circuitry for extracting 946, circuitry for clustering 948, and circuitry for sending/outputting 950. Processing with circuitry 942-950 may cause the imaging device 900 to perform the method 800 described with respect to FIG. 8, or any aspect related to it.

Various components of the imaging device 900 may provide means for performing the method 900 described with respect to FIG. 8, or any aspect related to it.

### Example Aspects Implementation examples are described in the following numbered clauses:

Aspect 1: A method for image processing by one or more processing units, comprising: obtaining a set of one or more raw images of a set of drill cutting samples; processing the set of one or more raw images to generate at least a trinary image dataset, a binary image dataset, or both; extracting a set of features from at least the trinary image dataset, the binary image dataset, or both; clustering the set of features to associate each of the drill cuttings with at least one representative class; and outputting the set of features and the at least one representative class associated with each of the drill cuttings.

Aspect 2: The method of aspect 1, wherein the drill cutting sample is a rock sample.

Aspect 3: An apparatus, comprising: a memory comprising executable instructions; and a processor configured to execute the executable instructions and cause the apparatus to perform a method in accordance with any one of Aspects 1-2.

Aspect 4: An apparatus, comprising means for performing a method in accordance with any one of Aspects 1-2.

Aspect 5: A non-transitory computer-readable medium comprising executable instructions that, when executed by a processor of an apparatus, cause the apparatus to perform a method in accordance with any one of Aspects 1-2.

Aspect 6: A computer program product embodied on a computer-readable storage medium comprising code for performing a method in accordance with any one of Aspects 1-2.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, decomposing, and the like.

The methods disclosed herein comprise one or more operations or actions for achieving the methods. The method operations and/or actions may be interchanged with one another without departing from the scope of the claims. In other words, unless a specific order of operations or actions is specified, the order and/or use of specific operations and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the Figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for image processing by one or more processing units, comprising:
obtaining a set of one or more raw images of a set of drill cutting samples;
processing the set of one or more raw images to generate at least a trinary image dataset, a binary image dataset, or both;
extracting a set of features from at least the trinary image dataset, the binary image dataset, or both;
clustering the set of features to associate each of the drill cuttings with at least one representative class; and
outputting the set of features and the at least one representative class associated with each of the drill cuttings.

2. The method of claim 1, wherein the drill cutting is a rock sample.

3. The method of claim 1, wherein the clustering comprises k-means clustering or Gaussian mixture models (GMM) clustering.

4. The method of claim 1, wherein extracting is performed using gray-level co-occurrence matrix analysis (GLCM), gray-level size-zone matrix (GLSZM), PCA, auto-encoders, or instance segmentation using distance transform watershed.

5. The method of claim 1, wherein processing further comprises:
overlapping high-resolution images of the drill cutting samples;
stitching where the one or more raw images overlap; and
processing a stitched image to obtain a super-resolution image of the drill cutting samples.

6. A non-transitory computer-readable medium comprising computer-executable instructions that, when executed by one or more processors, cause one or more processing units to:
obtain a set of one or more raw images of a set of drill cutting samples;
process the set of one or more raw images to generate at least a trinary image dataset, a binary image dataset, or both;
extract a set of features from at least the trinary image dataset, the binary image dataset, or both;
cluster the set of features to associate each of a drill cutting of the set of drill cuttings with at least one representative class; and
output the set of features and the at least one representative class associated with each of a drill cutting of the set of drill cuttings.

7. The non-transitory computer-readable medium of claim 6, wherein the drill cutting is a rock sample.

8. The non-transitory computer-readable medium of claim 6, wherein the clustering comprises k-means clustering or Gaussian mixture models (GMM) clustering.

9. The non-transitory computer-readable medium of claim 6, wherein extracting is performed using gray-level co-occurrence matrix analysis (GLCM), gray-level size-zone matrix (GLSZM), PCA, auto-encoders, or instance segmentation using distance transform watershed.

10. The non-transitory computer-readable medium of claim 6, wherein processing further comprises:
overlapping high-resolution images of the drill cutting samples;
stitching where the one or more raw images overlap; and
processing a stitched image to obtain a super-resolution image of the drill cutting samples.

11. An apparatus for image processing comprising a memory and one or more processing units, the one or more processing units configured to cause the apparatus to:
obtain a set of one or more raw images of a set of drill cutting samples;
process the set of one or more raw images to generate at least a trinary image dataset, a binary image dataset, or both;
extract a set of features from at least the trinary image dataset, the binary image dataset, or both;
cluster the set of features to associate each of a drill cutting of the set of drill cuttings with at least one representative class; and
output the set of features and the at least one representative class associated with each of a drill cutting of the set of drill cuttings.

12. The apparatus of claim 11, wherein the drill cutting is a rock sample.

13. The apparatus of claim 11, wherein the clustering comprises k-means clustering or Gaussian mixture models (GMM) clustering.

14. The apparatus of claim 11, wherein extracting is performed using gray-level co-occurrence matrix analysis (GLCM), gray-level size-zone matrix (GLSZM), PCA, auto-encoders, or instance segmentation using distance transform watershed.

15. The apparatus of claim 11, wherein processing further comprises:
overlapping high-resolution images of the drill cutting samples;
stitching where the one or more raw images overlap; and
processing a stitched image to obtain a super-resolution image of the drill cutting samples.
